(19) United States
(12) Patent Application Publication
(10) Pub. No.: US 2022/0405849 A1
(43) Pub. Date: Dec. 22, 2022

(54) Forecasting Cumulative Annual Activity of Major Tropical Cyclones and the Relevant Risk to Financial Assets

(71) Applicant: S&P Global Inc., New York, NY (US)

(72) Inventors: Alain Biem, New York, NY (US); Yuri Katz, Island Park, NY (US); Alka Dagar, New Delhi (IN); Rick David Lord, Victoria (AU)

(21) Appl. No.: 17/304,358

(22) Filed: Jun. 18, 2021

(51) Int. Cl. G06Q 40/08; G06Q 40/06; G06N 20/00; G01W 1/10

(52) U.S. Cl. CPC G06Q 40/08; G06Q 40/06; G06N 20/00; G01W 1/10

(57) ABSTRACT

A method, apparatus, system, and computer program code for determining a financial risk to a financial security. A computer system obtains historical time series of the annual counts of tropical cyclones globally and of the global mean sea surface temperature. Based on a time series of annual changes in cumulative annual counts of major tropical cyclones, the computer system trains a statistical model to make projections of the annual cumulative counts of major tropical cyclones globally. The computer system uses these projections to determine the physical risk to fixed assets. Based the physical risk to the fixed asset, the computer system updates an assumption of a financial model. The computer system analyzes the financial risk of the financial security based on the financial model and the assumption that was updated.

### BACKGROUND

### 1. Field

The disclosure relates generally to an improved computer system and, more specifically, to a method, apparatus, computer system, and computer program product for determining a financial risk to his financial security based on predicted annual cumulative counts of major tropical cyclones.

### 2. Description of the Related Art

Recent and intensifying natural disasters, such as the 2018 California wildfires and 2017 Hurricanes Harvey and Maria, are emblematic of a climate changed world and increase our understanding of the future social and economic consequences of climate change. Weather related catastrophic losses accounted for 80% of all insured losses in 2018.

The 2020 costs exceeded $95.0 billion, with Hurricane Laura, the August derecho and the historic Western wildfires as the costliest events [https://www.ncdc.noaa.gov/billions/time-series].

Changes in climate change physical risks, such as droughts, floods, and hurricanes, are expected to vary widely across the globe with existing hazards increasing in intensity in some regions and with other regions becoming subject to hazards not previously experienced. For example, scientific studies suggest that tropical cyclone rainfall rates and intensities are likely to increase due to climate change, and trends suggest that the locations at which cyclones reach maximum intensity is shifting poleward. These changes, combined with the increasingly global nature of corporate operations and supply chains, may present significant variation in the intensity and range of physical risk exposures across capital markets in different regions.

The physical risks caused by past and future inaction on climate change are contrasted with the potential risks and opportunities of ambitious action to limit climate change. Given the uncertainty around how the world will respond to the climate change challenge, it is critical that companies and investors understand how business models, supply chains and markets may change and evolve under future climate change scenarios. Strong action to limit climate change could result in significant technology, regulatory and market transition risks while inaction will result in the exacerbation of climate change along with the physical risks to assets, operations, and supply chains.

Companies and investors are exposed to a balance of transition and physical risks determined by the global response to climate change. Aggressive action to limit climate change to below 2 degrees Celsius (in accordance with the Paris Agreement) would likely increase transition risks whilst reducing physical risks globally. Conversely, limited action to reduce GHG emissions would limit key transition risks (such as technology, market, and regulatory risk), but would result in accelerating climate change and associated physical risks. This dynamic, combined with uncertainty around the global response to climate change, will require companies and investors to understand and plan for transition and physical risks across a range of future climate change scenarios.

### SUMMARY

According to one embodiment of the present invention, a method provides for determining a financial risk to a financial security. A computer system obtains historical time series of the annual counts of tropical cyclones globally and of the global mean sea surface temperature. Based on a time series of annual changes in cumulative annual counts of major tropical cyclones, the computer system trains a statistical model to make projections of the annual cumulative counts of major tropical cyclones globally. The computer system uses these projections to determine the physical risk score to fixed assets. Based the physical risk to the financial asset, the computer system updates an assumption of a financial model. The computer system analyzes the financial risk core of the financial security based on the financial model and the assumption that was updated.

According to another embodiment of the present invention, a computer system comprises a hardware processor and a risk calculator, in communication with the hardware processor. The risk calculator executes computer usable program code: to train a machine learning model on a first time series of tropical cyclones and a second time series of global mean sea surface temperatures; to predict using the machine learning model, annual cumulative counts of major tropical cyclones globally; to determine a physical risk score to a fixed asset based on the annual cumulative counts of major tropical cyclones; to update an assumption of a financial model based the physical risk to the fixed asset; and to analyze the financial risk of a financial asset based on the financial model and the assumption that was updated.

According to yet another embodiment of the present invention, a computer program product comprises a computer-readable storage media with program code stored on the computer-readable storage media for determining a financial risk to accept financial security. The program code is executable by a computer system and includes: program code for training a machine learning model on a first time series of tropical cyclones and a second time series of global mean sea surface temperatures; program code for predicting using the machine learning model, annual cumulative counts of major tropical cyclones globally; program code for determining a physical risk score to a fixed asset based on the annual cumulative counts of major tropical cyclones; program code for updating an assumption of a financial model based the physical risk score to the fixed asset; and program code for analyzing the financial risk of the financial security based on the financial model and the assumption that was updated.

### BRIEF DESCRIPTION OF THE DRAWINGS

FIG. 1 is a pictorial representation of a network of data processing systems in which illustrative embodiments may be implemented;

FIG. 2 is a block diagram of a risk evaluation environment depicted in accordance with an illustrative embodiment;

FIG. 3 is a graph of a time series of cumulative annual counts of severe hurricanes per an IPCC6 SSP1-2.6 scenario shown in accordance with an illustrative embodiment;

FIG. 4 is a graph of a time series of cumulative annual counts of severe hurricanes per an IPCC6 SSP5-8.5 scenario shown in accordance with an illustrative embodiment;

FIG. 5, a flowchart of a process for determining a financial risk to a financial security is depicted in accordance with an illustrative embodiment;

FIG. 6, a flowchart of a process for generating a time series based on annual changes in the annual cumulative counts of major tropical cyclones is depicted according to an illustrative embodiment;

FIG. 7, a flowchart of a process for generating a time series based on the annual global mean sea surface temperatures is depicted according to an illustrative embodiment;

FIG. 8, a flowchart of a process for determining the physical risk score to the fixed asset is depicted according to an illustrative example; and

FIG. 9 is a block diagram of a data processing system in accordance with an illustrative embodiment.

### DETAILED DESCRIPTION

The illustrative embodiments recognize and take into account one or more different considerations. For example, the illustrative embodiments recognize and take into account that changes in climate change physical risks, such as droughts, floods and hurricanes, are expected to vary widely across the globe with existing hazards increasing in intensity in some regions and with other regions becoming subject to hazards not previously experienced. For example, scientific studies suggest that tropical cyclone rainfall rates and intensities are likely to increase due to climate change, and trends suggest that the locations at which cyclones reach maximum intensity is shifting poleward. These changes, combined with the increasingly global nature of corporate operations and supply chains, may present significant variation in the intensity and range of physical risk exposures across capital markets in different regions.

The Intergovernmental Panel on Climate Change (IPCC) has adopted different Representative Concentration Pathways (RCPs) that differ in the projected atmospheric CO2. These sample scenarios, compare the projected radiant flux values for the year 2100 with the radiant flux in 1860, when systematic weather recording began. The difference between these values provides an estimate of the degree to which additional energy is reaching the Earth's surface over time. The IPCC Assessment Report (AR) 5 expresses this change as “radiative forcing,” measured in Watts per square meter (W/m2) and expressed as a multiple of the 1860 value.

Thus, the illustrative embodiments recognize and take into account that it would be desirable to have a method, apparatus, computer system, and computer program product that takes into account the issues discussed above as well as other possible issues. For example, it would be desirable to have a method, apparatus, computer system, and computer program product that allowing for making annual projections of the cumulative activity of major hurricanes per different IPCC AR5 RCP and IPCC AR6 SSP scenarios of anthropogenic global warming.

In one illustrative example, a computer system is provided determining a financial risk to his financial security. A computer system trains a machine learning model on a first time series of tropical cyclones and a second time series of global mean sea surface temperatures. Using the machine learning model, the computer system predicts cumulative counts of major tropical cyclones globally. Based on the annual cumulative counts of major tropical cyclones, the computer system determines the physical risk score to fixed assets. The computer system can then adjust an asset allocation in an investment portfolio based on the projected physical risk.

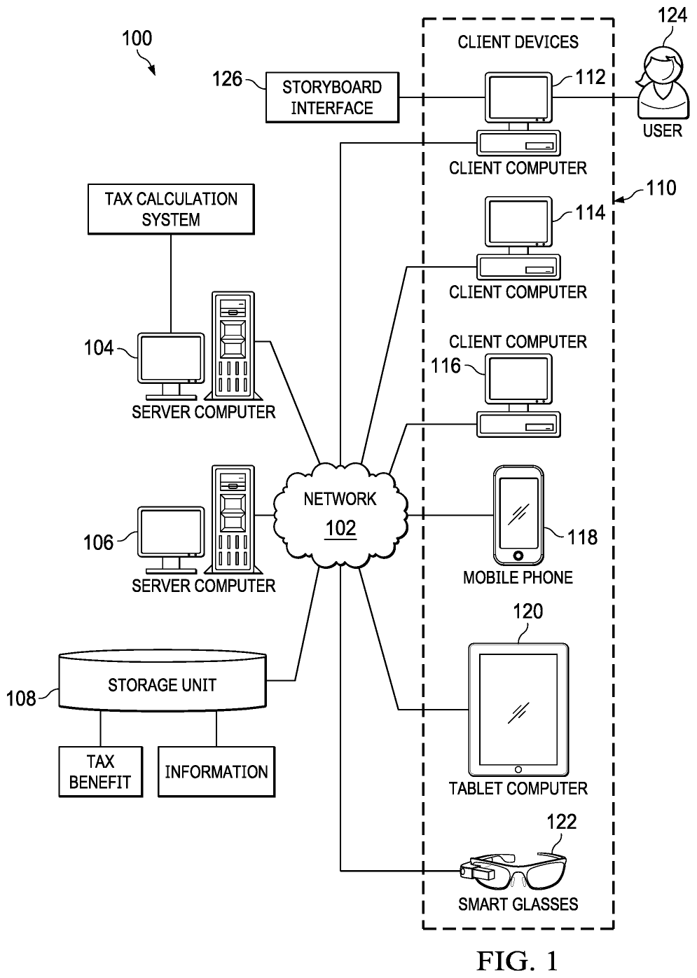

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, the program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “set of” or a “number of,” when used with reference to items, means one or more items. For example, a “set of different types of networks” or a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, user 124 operates client computer 112. As depicted, user instance 126 of an application runs on client computer 114. User 124 can interact with risk calculator 130 to generate the statistical models allowing to make annual projections of the cumulative activity of major hurricanes per different Intergovernmental Panel on Climate Change (IPCC) scenarios of anthropogenic global warming.

In this illustrative example, risk calculator 130 can run on client computer 114 and can take the form of a system instance of the application. In another illustrative example, risk calculator 130 can be run in a remote location such as on server computer 104. In yet other illustrative examples, risk calculator 130 can be distributed in multiple locations within network data processing system 100. For example, risk calculator 130 can run on client computer 112 and on client computer 114 or on client computer 112 and server computer 104 depending on the particular implementation.

Risk calculator 130 can operate to obtain historical time series of the annual counts of tropical cyclones globally and of the global mean sea surface temperature. Based on a time series of annual changes in cumulative annual counts of major tropical cyclones, risk calculator 130 can train a statistical model to make projections of the annual cumulative counts of major tropical cyclones globally. The risk calculator 130 can then use these projections to determine the physical risk to fixed assets. Based the physical risk score to the fixed asset, risk calculator 130 updates an assumption of a financial model. The risk calculator 130 analyzes the financial risk of the financial security based on the financial model and the assumption that was updated.

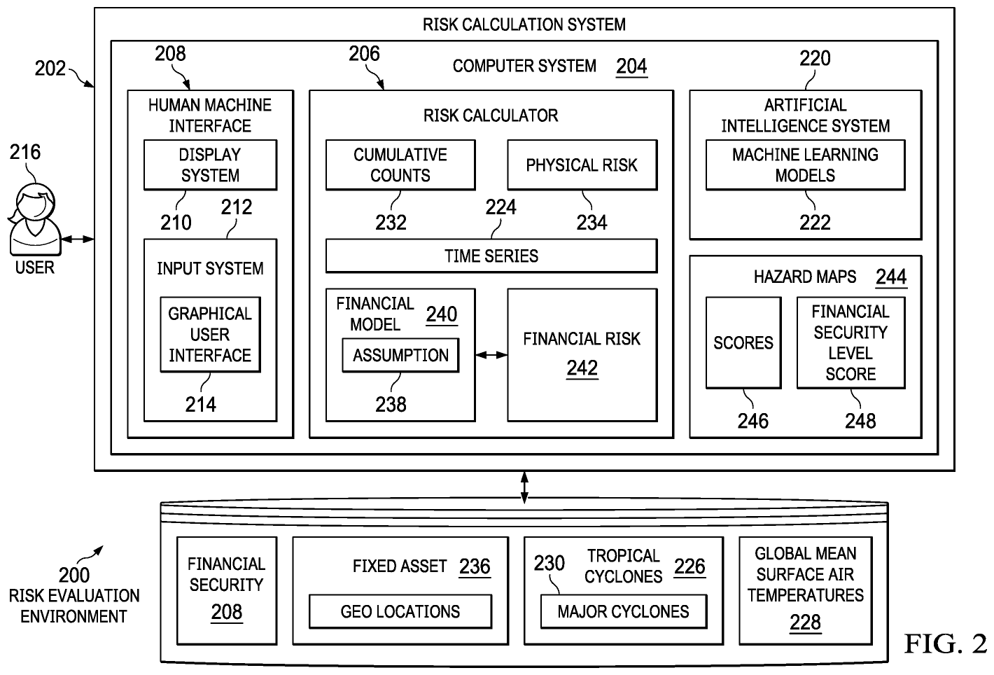

With reference now to FIG. 2, a block diagram of a risk evaluation environment is depicted in accordance with an illustrative embodiment. In this illustrative example, risk evaluation environment 200 includes components that can be implemented in hardware such as the hardware shown in network data processing system 100 in FIG. 1. In this illustrative example, the risk calculation system 202 in the risk evaluation environment 200 can be used to make annual projections of the cumulative activity of major hurricanes.

As depicted, risk calculation system 202 comprises computer system 204 and risk calculator 206. Risk calculator 206 runs in computer system 204. Risk calculator 206 can be implemented in software, hardware, firmware, or a combination thereof. When software is used, the operations performed by risk calculator 206 can be implemented in program code configured to run on hardware, such as a processor unit. When firmware is used, the operations performed by risk calculator 206 can be implemented in program code and data and stored in persistent memory to run on a processor unit. When hardware is employed, the hardware may include circuits that operate to perform the operations in risk calculator 206.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, human machine interface 208 comprises display system 210 and input system 212. Display system 210 is a physical hardware system and includes one or more display devices on which graphical user interface 214 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

User 216 is a person that can interact with graphical user interface 214 through user input generated by input system 212 for computer system 204. Input system 212 is a physical hardware system and can be selected from at least one of a mouse, a keyboard, a trackball, a touchscreen, a stylus, a motion sensing input device, a gesture detection device, a cyber glove, or some other suitable type of input device.

In this illustrative example, human machine interface 208 can enable user 216 to interact with one or more computers or other types of computing devices in computer system 204. For example, these computing devices can be client devices such as client devices 110 in FIG. 1.

In some illustrative examples, risk calculator 206 can use artificial intelligence system 220. Artificial intelligence system 220 is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, artificial intelligence system 220 can include a set of machine learning models 222. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, and anomaly detection, association rules, or other types of learning algorithms. Examples of machine learning models include an artificial neural network, a decision tree, a support vector machine, a Bayesian network, a genetic algorithm, and other types of models. These machine learning models can be trained using data and process additional data to provide a desired output.

In this illustrative example, risk calculator 206 in computer system 204 is configured to training a machine learning model 222 on a first one of time series 224 of tropical cyclones 226 and a second one of time series 224 of global mean sea surface temperatures 228.

In one illustrative example, risk calculator 206 identifies annual counts of major tropical cyclones 230 of category 3 and above on a Saffir-Simpson Hurricane Wind Scale. Risk calculator 206 can then generate the first one of time series 224 based on annual changes in the annual cumulative counts of major tropical cyclones 230.

In one illustrative example, risk calculator 206 identifies annual global mean sea surface temperatures 228. Risk calculator 206 can then generate the second one of time series 224 based on the annual global mean sea surface temperatures 228.

As used herein, a “tropical cyclone” is a rotating, organized system of clouds and thunderstorms that originates over tropical or subtropical waters and has a closed low-level circulation. A hurricane is a tropical cyclone with maximum sustained winds of 74 mph (64 knots) or higher. A major hurricane, or major cyclone, is tropical cyclone with maximum sustained winds of 111 mph (96 knots) or higher, corresponding to a Category 3, 4 or 5 on the Saffir-Simpson Hurricane Wind Scale.

In one illustrative example, machine learning model 222 may utilize an auto-regressive integrated moving average (ARIMA) as a forecasting model. ARIMA is a way of modeling time series data for forecasting (i.e., for predicting future points in the time series). An ARIMA model is a particular type of regression model in which the dependent variable has been detrended (stationarized). The independent variables are all lags of the dependent variable and/or lags of the errors, so it is straightforward in principle to extend an ARIMA model to incorporate information provided by leading key performance indicators and other exogenous variables. Essentially, risk calculator 206 adds time series 224 of global mean sea surface temperatures 228 as regressors to the forecasting equation below:

Ŷₜ=μ+ϕ₁Yₜ₋₁−θ₁eₜ₋₁+β(Xₜ−ϕ₁Xₜ₋₁)

wherein:

Yₜ is a number of major cyclones recorded for a current period t;

Yₜ₋₁ is the number of major cyclones recorded for the previous period t−1;

Xₜ is a global mean sea surface temperature for the current period t; and

Xₜ₋₁ is the global mean sea surface temperatures for the previous period t−1.

Using the trained machine learning model 222, risk calculator 206 predicts cumulative counts 232 of major tropical cyclones 230 globally. In this illustrative example, machine learning model 222 can be an ARIMA statistical model with an external regression on the second one of time series 224 of the global mean sea surface temperatures 228. Once trained, risk calculator 206 may validate the machine learning model 222 on the first one of time series 224 to ensure desired level of performance.

In one illustrative example, risk calculator 206 can determine the physical risk score 234 to a fixed asset 236 based on the annual cumulative counts 232 of major cyclones 230.

As used herein, the term “fixed asset” is a long-term tangible piece of property or equipment that a firm owns and uses in its operations to generate income. Fixed assets are not expected to be consumed or converted into cash within a year. Fixed assets most commonly appear on the balance sheet as property, plant, and equipment (PP&E). They are also referred to as capital assets.

In one illustrative example, risk score calculator 206 updates an assumption 238 of a financial model 240 based the physical risk score 234 to the financial asset 236. As used herein, the term “financial model” is a system, quantitative method, or approach that relies on assumptions and economic, statistical, mathematical, or financial theories and techniques to process data inputs into a quantitative-estimate type of output. These can include scorecards, loan pricing, expected loss models, and unexpected loss models (i.e., economic capital, regulatory capital, stress testing). The purpose of the financial model is to estimate a financial outcome if a certain action is taken, or a possible event occurs.

A financial model, such as financial model 240 is also only as good as the inputs and assumptions that go into it. As used herein, the term “assumption” is an estimate of an uncertain variable input into a financial model. Assumptions made to develop a financial model and inputs into the model can vary widely. This includes assumptions, identified through prior scientific research, specifying the quantitative relationship between a hurricane event and a tangible interruption of business activities or asset function, and the relationship between business interruption or asset impairment and financial indicators such as revenue or capital value. Financial model 240 may perform inadequately when assumptions 238 are incorrect. For example, incorrect assumptions regarding the frequency of natural disasters may affect the financial risk 242 to an asset-backed security.

Based on the financial model 240 and the assumption 238 that was updated, risk score calculator 206 can analyzing the financial risk of the financial security. As used herein, the term “financial risk” refers to the chance an outcome or investment's actual gains will differ from an expected outcome or return. Financial risk includes the possibility of losing some or all of an original investment in a financial security.

As used herein, the term “financial security” is a fungible, negotiable financial instrument that holds some type of monetary value. It represents an ownership position in a publicly-traded corporation-via stock-a creditor relationship with a governmental body or a corporation-represented by owning that entity's bond-or rights to ownership as represented by an option.

A financial security may be an asset-backed security. As used herein, an asset-backed security (ABS) is a financial security such as a bond or note which is collateralized by a pool of assets such as loans, leases, credit card debt, royalties, or receivables. Assets backing an asset-backed security may be fixed assets, such as fixed asset 236.

In one illustrative example, risk calculator 206 may generate hazard maps 244 in determining the physical risk 234 to the fixed asset 236. As used herein, the term “hazard map” is a map that highlights areas that are affected by or are vulnerable to a particular hazard. For example, risk calculator 206 may generate one or more hazard maps 244 representing a relative level of risk for major tropical cyclones 230. In this illustrative example, risk calculator 206 may geolocate the fixed assets 236 on the hazard maps 244, scoring each fixed asset 236 based on a relative level of risk. The scores 246 for the multiple ones of fixed assets 236 may then be aggregated to a financial security level score 248 that is calculated as a weighted average of the scores 246 for the fixed assets 236, weighted for company-specific sensitivity.

In one illustrative example, one or more solutions are present that that allowing for making annual projections of the cumulative activity of major hurricanes per different IPCC5 and IPCC6 scenarios of anthropogenic global warming. As a result, one or more illustrative examples may provide more accurate financial models for determining a financial risk to an asset-backed financial security.

Computer system 204 can be configured to perform at least one of the steps, operations, or actions described in the different illustrative examples using software, hardware, firmware, or a combination thereof. As a result, computer system 204 operates as a special purpose computer system in risk calculator 206 in computer system 204. In particular, risk calculator 206 transforms computer system 204 into a special purpose computer system as compared to currently available general computer systems that do not have risk calculator 206. In this example, computer system 204 operates as a tool that can increase at least one of speed, accuracy, or usability of computer system 204. In particular, this increase in performance of computer system 204 can be for the generation of financial models 240. In one illustrative example, risk calculator 206 provides for more accurate assumptions 238 regarding physical risk 234 to fixed assets 236, as compared with using current risk evaluation systems.

The illustration of risk evaluation environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

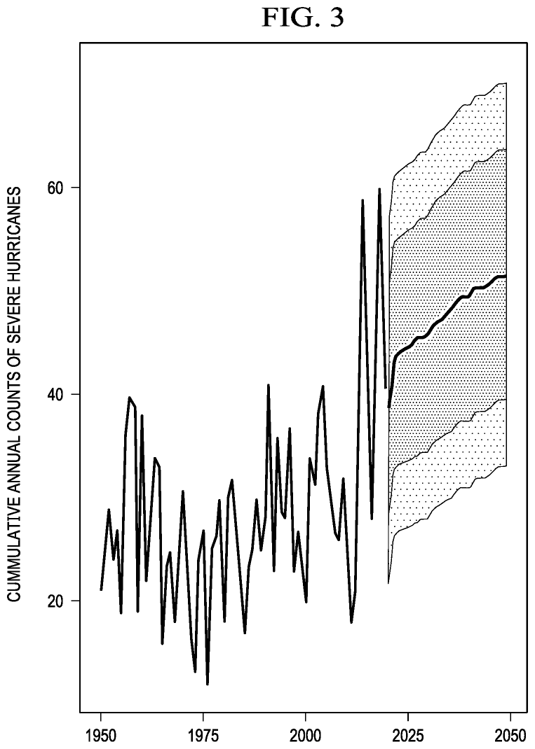

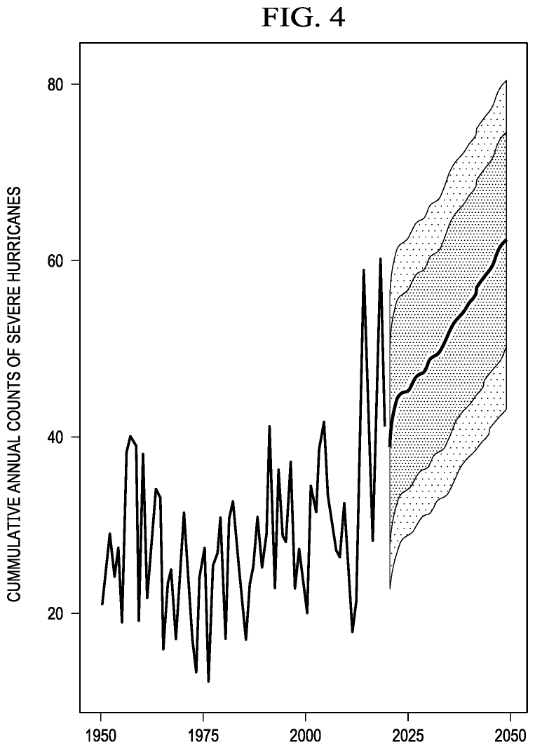

Turning now to FIGS. 3-4, illustrations of time series of cumulative annual counts of severe hurricanes per different IPCC6 SSP scenarios are shown in accordance with an illustrative embodiment.

FIG. 3 illustrates a SSP1-2.6 scenario. Predicted cumulative counts, as determined by risk calculator 206 of FIG. 2, are illustrated at confidence intervals of 95% and 80%.

FIG. 4 illustrates a SSP5-8.5 scenario. Predicted cumulative counts, as determined by risk calculator 206 of FIG. 2, are illustrated at confidence intervals of 95% and 80%.

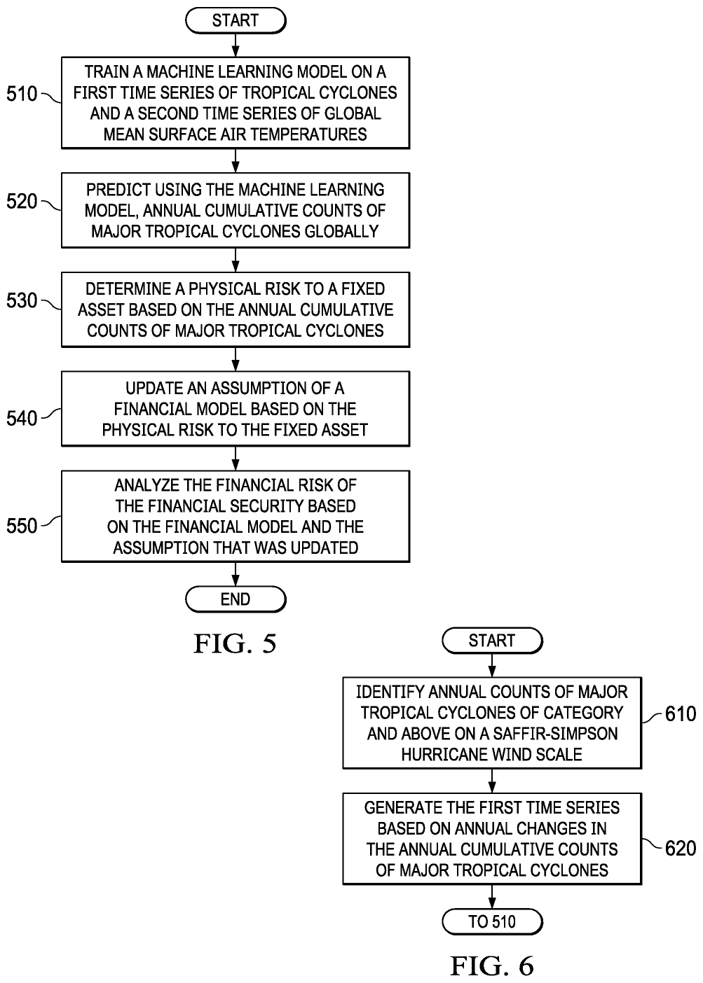

Turning next to FIG. 5, a flowchart of a process for determining a financial risk to a financial security is depicted in accordance with an illustrative embodiment.

The process in FIG. 5 can be implemented in hardware, software, or both. When implemented in software, the process can take the form of program code that is run by one or more processor units located in one or more hardware devices in one or more computer systems. For example, the process can be implemented in risk calculator 206 in computer system 204 in FIG. 2.

The process begins by training a machine learning model on a first time series of tropical cyclones and a second time series of global mean sea surface temperatures (step 510). In one illustrative example, the machine learning model is an ARIMA statistical model with an external regression on the second time series of the global mean sea surface temperature. In one illustrative example, the process may validate the machine learning model using the first time series to ensure desired level of performance.

Using the machine learning model, the process predicts annual cumulative counts of major tropical cyclones globally (step 520) and determines a physical risk to a fixed asset based on the annual cumulative counts of major tropical cyclones (step 530). based the physical risk to the fixed asset, the process updates an assumption of a financial model (step 540). The process analyzes the financial risk of the financial security based on the financial model and the assumption that was updated (step 550) and terminates thereafter.

With reference next to FIG. 6, a flowchart of a process for generating a time series based on annual changes in the annual cumulative counts of major tropical cyclones is depicted according to an illustrative embodiment. The process in FIG. 6 can be implemented as a preliminary step to process step 510 of FIG. 5.

The process identifies annual counts of major tropical cyclones of category and above on a Saffir-Simpson Hurricane Wind Scale (step 610). The process generates the first time series based on annual changes in the annual cumulative counts of major tropical cyclones (step 620). Thereafter, the process can continue to step 510 of FIG. 5.

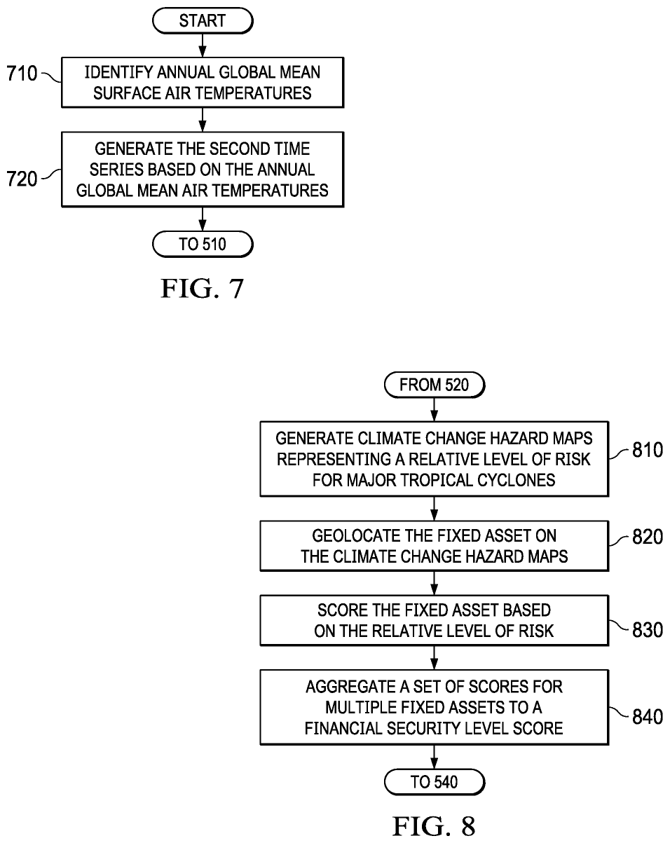

With reference next to FIG. 7, a flowchart of a process for generating a time series based on the annual global mean sea surface temperatures is depicted according to an illustrative embodiment. The process in FIG. 7 can be implemented as a preliminary step to process step 510 of FIG. 5.

The process identifies annual global mean sea surface temperatures (step 710). The process generates the first time series based on annual changes in the annual global mean sea surface temperatures (step 620). Thereafter, the process can continue to step 510 of FIG. 5.

With reference next to FIG. 8, a flowchart of a process for determining the physical risk to the fixed asset is depicted according to an illustrative example. The process of FIG. 8 is one example in which process step 540 of FIG. 5 can be implemented.

Continuing from step 520 of FIG. 5, the process generates climate change hazard maps representing a relative level of risk for major tropical cyclones (step 810), and geolocates the business assets on the climate change hazard maps (step 820). based on the relative level of risk as indicated on the hazard map, the process scores the fixed asset (step 830). The process can then aggregate scores for multiple fixed assets to a financial security level score (step 840). Thereafter, the process can continue to step 540 of FIG. 5.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a modules, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

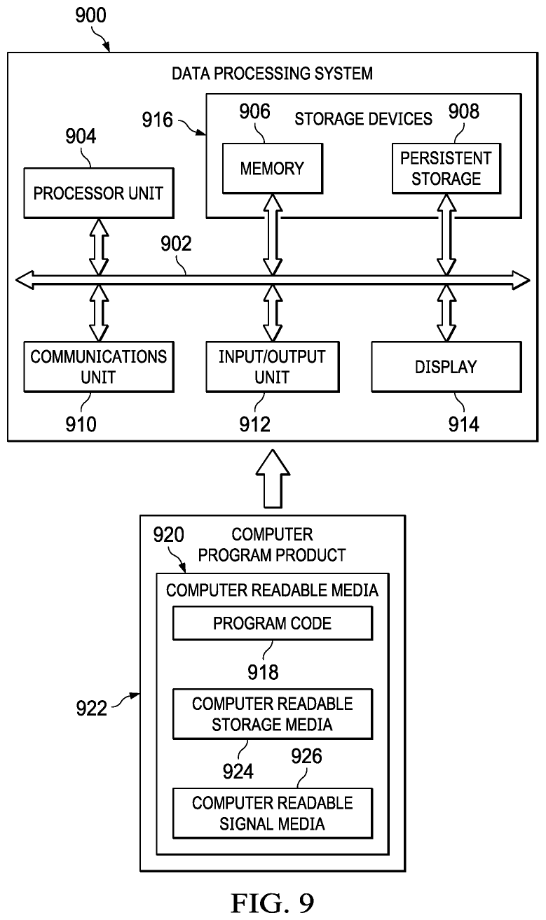

Turning now to FIG. 9, a block diagram of a data processing system is depicted in accordance with an illustrative embodiment. Data processing system 900 can be used to implement server computer 104, server computer 106, client devices 110, in FIG. 1. Data processing system 900 can also be used to implement computer system 204 in FIG. 2. In this illustrative example, data processing system 900 includes communications framework 902, which provides communications between processor unit 904, memory 906, persistent storage 908, communications unit 910, input/output (I/O) unit 912 and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can may be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are program instructions and are also referred are referred to as program code, computer usable program code, or computer-readable program code that can be read and executed by a processor in processor unit 904. The program code in the different embodiments can be embodied on different physical or computer-readable storage media, such as memory 906 or persistent storage 908.

Program code 918 is located in a functional form on computer-readable media 920 that is selectively removable and can be loaded onto or transferred to data processing system 900 for execution by processor unit 904. Program code 918 and computer-readable media 920 form computer program product 922 in these illustrative examples. In the illustrative example, computer-readable media 920 is computer-readable storage media 924.

In these illustrative examples, computer-readable storage media 924 is a physical or tangible storage device used to store program code 918 rather than a medium that propagates or transmits program code 918. Computer-readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The term “non-transitory” or “tangible”, as used herein, is a limitation of the medium itself (i.e., tangible, not a signal) as opposed to a limitation on data storage persistency (e.g., RAM vs. ROM).

Alternatively, program code 918 can be transferred to data processing system 900 using a computer-readable signal media. The computer-readable signal media are signals and can be, for example, a propagated data signal containing program code 918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 920” can be singular or plural. For example, program code 918 can be located in computer-readable media 920 in the form of a single storage device or system. In another example, program code 918 can be located in computer-readable media 920 that is distributed in multiple data processing systems. In other words, some instructions in program code 918 can be located in one data processing system while other instructions in program code 918 can be located in one data processing system. For example, a portion of program code 918 can be located in computer-readable media 920 in a server computer while another portion of program code 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of, another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program code 918.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A method for determining a financial risk to a financial security, the method comprising:
training, by a computer, a machine learning model on a first time series of tropical cyclones and a second time series of global mean sea surface temperatures;
predicting, by the computer, using the machine learning model, annual cumulative counts of major tropical cyclones globally;
determining, by the computer, a physical risk to a fixed asset based on the annual cumulative counts of major tropical cyclones;
updating an assumption of a financial model based the physical risk to the fixed asset; and
analyzing the financial risk of the financial security based on the financial model and the assumption that was updated.

2. The method of claim 1, wherein the machine learning model is an auto-regressive integrated moving average (AIRIMA) statistical model with an external regression on the second time series of the global mean sea surface temperature.

3. The method of claim 1, wherein the financial security is a financial instrument that holds some type of monetary value, and further comprising:
identifying, by the computer, annual cumulative counts of major tropical cyclones of category 3 and above on a hurricane wind scale; and
generating, by the computer, the first time series based on annual changes in the annual cumulative counts of major tropical cyclones.

4. The method of claim 1, wherein the financial security is a financial instrument that holds some type of monetary value, and further comprising:
identifying, by the computer, annual global mean sea surface temperatures; and
generating, by the computer, the second time series based on the annual global mean sea surface temperatures.

5. The method of claim 1, further comprising:
validating, by the computer, the machine learning model on the first time series of tropical cyclones.

6. The method of claim 1, wherein the financial security is a financial instrument that holds some type of monetary value, and wherein determining the physical risk to the fixed asset further comprises:
generating, by the computer, climate change hazard maps representing a relative level of risk for major tropical cyclones;
geolocating, by the computer, the fixed asset on the climate change hazard maps;
scoring, by the computer, the fixed asset based on the relative level of risk; and
aggregating, by the computer, a set of scores for multiple fixed assets to a financial security level score.

7. The method of claim 6, wherein the financial security level score is calculated as a weighted average of the scores for the fixed asset, weighted for company-specific sensitivity, and wherein the financial model estimates a financial outcome with respect to at least one of a certain action is taken and a given event occurs.

8. A computer system for determining a financial risk to a financial security, the method comprising:
a hardware processor; and
a risk calculator, in communication with the hardware processor, wherein the risk calculator executes computer usable program code:
to train a machine learning model on a first time series of tropical cyclones and a second time series of global mean sea surface temperatures;
to predict using the machine learning model, annual cumulative counts of major tropical cyclones globally;
to determine a physical risk to a fixed asset based on the annual cumulative counts of major tropical cyclones;
to update an assumption of a financial model based on the physical risk to the fixed asset; and
to analyze the financial risk of the financial security based on the financial model and the assumption that was updated.

9. The computer system of claim 8, wherein the machine learning model is an auto-regressive integrated moving average (AIRIMA) statistical model with an external regression on the second time series of the global mean sea surface temperature.

10. The computer system of claim 8, wherein the financial security is a financial instrument that holds some type of monetary value, and wherein the risk calculator further executes program code:
to identify annual cumulative counts of major tropical cyclones of category 3 and above on a hurricane wind scale; and
to generate the first time series based on annual changes in the annual cumulative counts of major tropical cyclones.

11. The computer system of claim 8, wherein the financial security is a financial instrument that holds some type of monetary value, and wherein the risk calculator further executes program code:
to identify annual global mean sea surface temperatures; and
to generate the second time series based on the annual global mean sea surface temperatures.

12. The computer system of claim 8, wherein the risk calculator further executes program code:
to validate the machine learning model on the first time series of tropical cyclones.

13. The computer system of claim 8, wherein the financial security is a financial instrument that holds some type of monetary value, and wherein in determining the physical risk to the fixed asset, the risk calculator further executes program code:
to generate climate change hazard maps representing a relative level of risk for major tropical cyclones;
to geolocate the fixed asset on the climate change hazard maps;
to score the fixed asset based on the relative level of risk; and
aggregate a set of scores for multiple fixed assets to a financial security level score.

14. The computer system of claim 13, wherein the financial security level score is calculated as a weighted average of the scores for the fixed asset, weighted for company-specific sensitivity, and wherein the financial model estimates a financial outcome with respect to at least one of a certain action is taken and a given event occurs.

15. A computer program product comprising:
a computer readable storage media; and
program code, stored on the computer readable storage media, for determining a financial risk to a financial security, the program code comprising:
program code for training a machine learning model on a first time series of tropical cyclones and a second time series of global mean sea surface temperatures;
program code for predicting using the machine learning model, annual cumulative counts of major tropical cyclones globally;
program code for determining a physical risk to a fixed asset based on the annual cumulative counts of major tropical cyclones;
program code for updating an assumption of a financial model based on the physical risk to the fixed asset; and
program code for analyzing the financial risk of the financial security based on the financial model and the assumption that was updated.

16. The computer program product of claim 15, wherein the machine learning model is an auto-regressive integrated moving average (AIRIMA) statistical model with an external regression on the second time series of the global mean sea surface temperature.

17. The computer program product of claim 15, wherein the financial security is a financial instrument that holds some type of monetary value, and wherein the program code further comprises:
code for identifying annual cumulative counts of major tropical cyclones of category 3 and above on a hurricane wind scale; and
code for generating the first time series based on annual changes in the annual cumulative counts of major tropical cyclones.

18. The computer program product of claim 15, wherein the financial security is a financial instrument that holds some type of monetary value, and wherein the program code further comprises:
code for identifying annual global mean sea surface temperatures; and
code for generating the second time series based on the annual global mean sea surface temperatures.

19. The computer program product of claim 15, wherein the program code further comprises:
code for validating the machine learning model on the first time series of tropical cyclones.

20. The computer program product of claim 15, wherein the financial security is a financial instrument that holds some type of monetary value, and wherein the program code for determining the physical risk to the fixed asset further comprises:
program code for generating climate change hazard maps representing a relative level of risk for major tropical cyclones;
program code for geolocating the fixed asset on the climate change hazard maps;
program code for scoring the fixed asset based on the relative level of risk; and
program code for aggregating a set of scores for multiple fixed assets to a financial security level score.

21. The computer program product of claim 20, wherein the financial security level score is calculated as a weighted average of the scores for the fixed asset, weighted for company-specific sensitivity, and wherein the financial model estimates a financial outcome with respect to at least one of a certain action is taken and a given event occurs.
